(19) United States
(12) Patent Application Publication
(10) Pub. No.: US 2005/0007246 A1
(43) Pub. Date: Jan. 13, 2005

(54) System and method of automatically activating vehicle hazard light in the event of engine stall

(76) Inventors: Kun Yen, Rowland HTS, CA (US); I-Wei Hsu, Hacienda Height, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/616,539

(22) Filed: Jul. 9, 2003

(51) Int. Cl. B60Q 1/52

(52) U.S. Cl. 340/471

(57) ABSTRACT

A system in a motor vehicle having a hazard warning light and a manual control switch, an improvement consisting of electronic circuitry which causes the hazard warning lights to automatically activate under circumstances of an engine stall and to remain activated until manually reset by the vehicle operator, said system comprising: a detecting means (4) for detecting an engine stall while the ignition switch is switched on; a signal generating means (6) responsive to said detecting means (4) for generating a flashing signal upon signaling by the detecting means (4) of an engine stall; and a manual control means (12) connected to the hazard warning light for manually activating and deactivating the hazard warning light.

### BACKGROUND OF THE INVENTION

The present invention relates to a system to automatically activate a vehicle's hazard warning light upon an engine stall.

The automotive industry is booming rapidly. Every manufacturer is spending time on various timing functions, such as rapid start in a short period of time, safely braking a car in the shortest period of time, etc. However, no considerations have been made in regard to the possible fatal hazard of an engine stall during driving and activating the flashing hazard lights to warn the following cars.

Once an engine stall occurs, a warning signal, transmitted by the alternator, is transmitting an instruction to activate the system. The system then automatically activates hazards the warning lights to warn the following cars so that unnecessary accidents and casualties can be avoided. However, most car manufacturers keep focusing on improvements to comfort, mechanic efficiency, fuel saving devices, interior and exterior designs, and driver and passenger safety. The hazard lights still need to be turned on manually, which is malapropos without improvement.

Currently, the operator has to activate the hazard warning lights manually when the engine stops abnormally during driving system. Especially when driving at high speed, an inexperienced driver might be frightened such that he/she forgets or is slow to turn on the hazard warning lights. This circumstance often occurs for a new driver, a new car owner or a car renter who would take more time to locate the switch to turn on the lights such that the following cars can not be warned in advance and cause unnecessary casualties and financial loss.

Drivers who are inexperienced, usually try to crank start the engine when the engine stall occurs, rather than shift the gear to neutral or park for the engine re-start process, and turning on the hazard warning lights in such tens of seconds to warn the on-coming cars. This will cause a pileup because of the delayed warning.

Today, electronic control systems provide accurate and comfortable driving conditions. Therefore, many drivers do not pay too much attention to driving. In addition, a lot of unpredictable hazards can occur such as abnormal engine stalls. A pileup may happen if the driver forgets or is slow to turn on the hazard warning lights when the hazard occurs to warn the on-coming cars. We understand it is necessary to develop a system to turn on the hazard warning lights automatically to avoid unnecessary accidents and casualties.

Even for an experienced driver, it takes more than ten seconds to turn on the hazard warning lights when an abnormal engine stall occurs. The golden ten seconds is the best time to deal with the crisis. An automatically activated hazard warning light system according to the present invention is then specially designed to fulfill this demand.

The automatically activated hazard warning lights according to the present invention protects consumers from worrying about the following cars when the engine stall occurs and the switch for turning on the hazard warning lights can not be found in time. Furthermore, the system can warn the following cars in advance in time for them to take proper action to avoid unnecessary accidents and casualties.

One very important concept of the present invention is that most drivers try to re-start the engine when the hazard warning lights automatically turning on due to the abnormal engine stall. However, if re-starting the engine terminates the hazard warning lights and the engine does not restart to, this will cause a temporary operation causing further chaos and crisis. Therefore, it is necessary to maintain a manual control system for the hazard warning lights to wait for and make sure the car and engine are back in normal running condition. Or, the driver may turn off the hazard warning lights after the car has been towed such that the safety of the driver can be assured.

U.S. Pat. No. 4,990,887 discloses a brake light arrangement that provides a time delay in the extinguishing of lighted brake lights. Thus, when the lights are energized they will continue to be illuminated for a predetermined period of time.

U.S. Pat. No. 5,139,115 discloses a system in which the brake lights are lighted in the usual manner under normal braking conditions but flash when the anti-lock braking system of the vehicle is activated.

U.S. Pat. No. 6,023,221 discloses an automotive safety system that will automatically activate hazard warning lights under circumstances of hard braking or sudden stoppage. The system incorporates an accelerometer which measures the longitudinal acceleration of the vehicle and a microcontroller which processes the acceleration readings. When a series of deceleration values in excess of a predetermined threshold is detected, the microcontroller transmits an activation signal and the hazard warning lights are activated to warn other motorists. The prior art fails to show a system and method for automatically activating a vehicle's hazard light for an engine stall

### SUMMARY OF THE INVENTION

A system in a motor vehicle having hazard warning lights and a manual control switch, an improvement consisting of electronic circuitry which causes the hazard warning lights to automatically activate under circumstances of engine stall such as engine failure, engine crash, engine choking, engine dies, etc., and to remain activated until manually reset by the vehicle operator, said system comprising: detecting means 4 for detecting an engine stall while the ignition switch is switched on, signal generating means 6 responsive to said detecting means 4 for generating a flashing signal upon signalling by the detecting means 4 of an engine stall; and manual control means 12 connected to the hazard warning lights for manually activating and deactivating the hazard warning lights.
(1) When a driver is driving a vehicle and all the sudden the engine is failed abnormally, it might be caused by the malfunction of machine, electric, gas loop system, or alternator causing the engine stop.
(2) The characteristic of the design according to the present invention is that the automatic activating vehicle hazard light system which does not affect the original manual operations is attached to the existed manual hazard light signal system. The existed system can be operated independently and connected to the system of the present invention providing additional functions to the emergency hazard light. That is, the system according the present invention is compatible to the existed emergency hazard light devices without affecting the original operations.
(3) The design of the present invention applies to the abnormal operations of engine extinguishment or failure cranking. The system is activated when abnormal operation signals are received. The vehicle safe system will activate hazard light automatically unless the “Reset Switch” is pressed.
(4) Vehicle manufacturer might want to improve the existed hazard light device and manual control switch and to improve the electric structure for controlling hazard light automatically and then utilize the signals of the engine abnormal operations. Therefore, the present invention would like to disclose the following features:
   (a) The definition of engine failure is originated from machine malfunction, electric malfunction, gas loop system malfunction, alternator malfunction, etc., causing the engine failure abnormally.
   (b) According to the design of the present invention, the system can be implemented by either IC control or Relay control.

The light of the system can be implemented in any color such as white, yellow, red flash light, or brake flash light.

The foregoing and other objects, features, and advantages of the invention will become more apparent from the following detailed description of a preferred embodiment which proceeds with reference to the accompanying drawings.

### BRIEF DESCRIPTION OF THE DRAWINGS

FIG. 1 is a block diagram of a system according to the invention.

### DETAILED DESCRIPTION OF THE INVENTION

Preferred Embodiment:

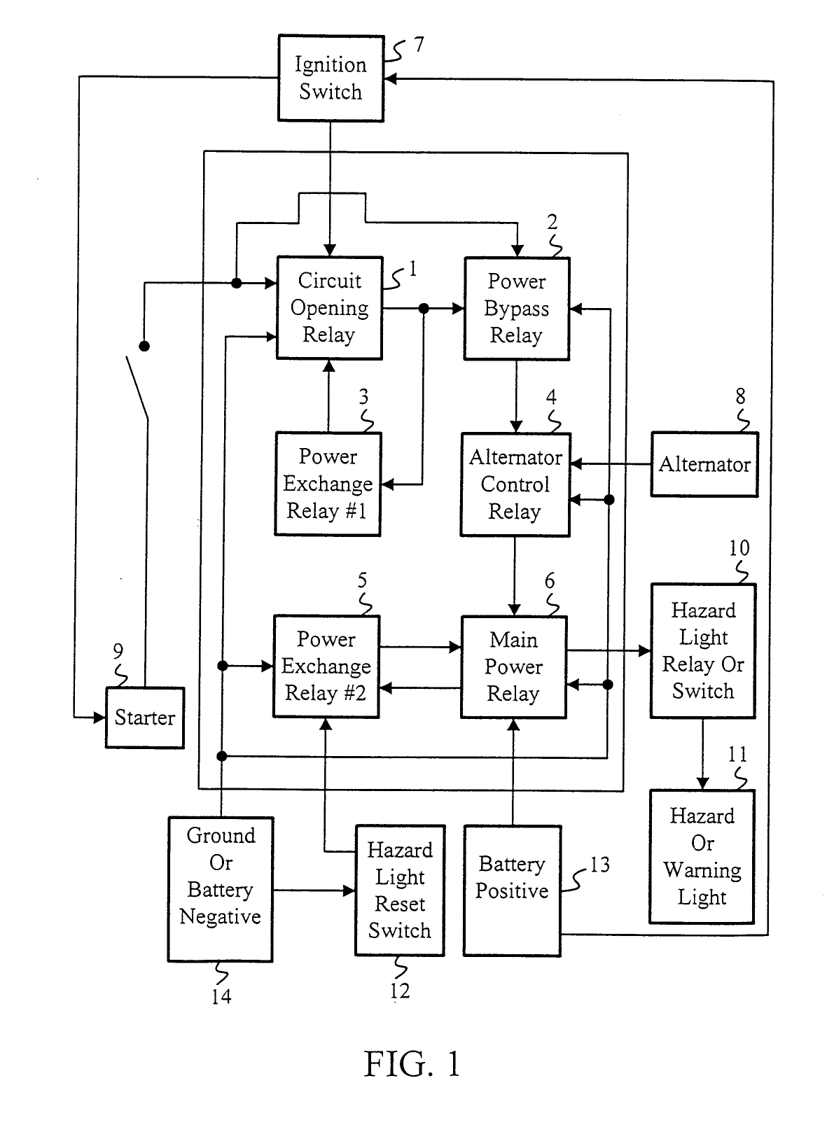

Please refer to FIG. 1. When a car is in the normal parking condition, the ignition switch 7 is in the “off” state, a current from a power source 13, typically a battery positive pole in a vehicle, is received by the system of the present invention and passed to a signal generating means 6, an ignition switch 7, and a second power exchange relay 5. Arrows illustrated in the figure represent the directions of the current flow. At this standby stage, all devices operate normally and safely.

When the ignition switch 7 is positioned to “cranking starter”, the system starts operating. A signal (current) from the ignition switch 7 is transmitted to a starter 9, a circuit opening relay, and a power bypass relay 2 which protects the system from being interfered with during engine cranking. Simultaneously a signal is sent by the circuit opening relay 1 to a first power exchange relay 3 such that an internally isolated current system is established.

After the engine has been started and is running normally, input signals from the power bypass relay 2 and the alternator 8 are transmitted into a detecting means 4, for example, an alternator control relay, to complete a detection process and continuously monitor the engine operation.

Once an engine stall occurs, signals from the ignition switch 7 and starter 9 transmitted to the circuit opening relay 1 and the power bypass relay 2 and signal from alternator 8, are received by the detecting means 4 activating the signal generating means 6. The activation of the signal generating means 6 blocks signals from the ignition switch 7, alternator 8, and starter 9 such that an isolated current system, which is not affected by the signals from the ignition switch 7, alternator 8, and starter 9 is established such that the signal from the signal generating means 6 is passed into a hazard light relay or switch 10 and a hazard light or warning light 11. Once the means 10 and 11 are started, they will not be stopped automatically.

For turning off the automotive auto flash hazard warning light controller, car operators can press a “Reset” button to activate a hazard light reset switch 12 such that a current signal will be transmitted from the hazard light reset switch 12 to the second power exchange relay 5 which turns off the signal generating means 6 and further turns off means 10 and 11. The current and system are then terminated and return to the parking stage.

Having illustrated and described the principles of the invention in a preferred embodiment, it should be apparent to those skilled in the art that the invention can be modified in arrangement and detail without departing from such principles. For example, the described, discrete embodiment may also be fabricated in monolithic form on an integrated circuit as is known in the art. We claim all modifications coming within the spirit and scope of the following claims.

Reference Numerals for Major Parts

1 circuit opening relay
2 power bypass relay
3 first power exchange relay
4 alternator control relay
5 second power exchange relay
6 main power relay
7 ignition switch
8 alternator
9 starter
10 hazard light relay or switch
11 hazard or warning light
12 hazard light reset switch
13 battery positive
14 ground or battery negative

1. A system for automatically activating a hazard warning light under circumstances of an engine stall of a motor vehicle, comprising:
detecting means for detecting the engine stall while an ignition switch is switched on; and
signal generating means responsive to said detecting means for activating the warning light to generate a flashing signal upon signalling by the detecting means of the engine stall.

2. The system according to claim 1, further comprising manual control means connected to the hazard warning light for manually activating or deactivating the hazard warning light.

3. The system according to claim 1, further comprising a circuit open relay coupled to said ignition switch for signaling a first power exchange relay to establish an internally isolated current system, and a power bypass relay coupled to said ignition switch for preventing interference while said ignition switch is switched to cranking the starter position.

4. The system according to claim 1, wherein said detecting means is fed by signals from both said power bypass relay and an alternator simultaneously after said engine is started and running.

5. The system according to claim 1, wherein said detecting means is fed by signals from said ignition switch, alternator, and a starter when said engine stalls, and blocking these three signals upon the activation of signal generating means.

6. The system according to claim 1, in which the hazard warning light is a signaling light.

7. The system according to claim 1, in which the hazard warning light is a braking light

8. The system according to claim 1, in which the hazard warning light is a backup light.

9. A method for automatically activating a hazard warning light under circumstances of an engine stall of a motor vehicle, comprising the steps of:
detecting the engine stall by detecting means while an ignition switch is switched on; and
responsive to said detecting means by signal generating means for activating the warning light to generate a flashing signal upon signalling by the detecting means of the engine stall.

10. The method according to claim 9 further comprising the step of manually activating or deactivating the hazard warning light by a manual control means connected to the hazard warning light.

11. The method according to claim 9 further comprising the steps of:
signaling a first power exchange relay to establish an internally isolated current system a circuit open relay coupled to said ignition switch; and
preventing interference while said ignition switch is switched to cranking the starter position by a power bypass relay coupled to said ignition switch.

12. The method according to claim 9, wherein said detecting the engine stall receives signals from both said power bypass relay and an alternator simultaneously after said engine is started and running.

13. The method according to claim 9, wherein said detecting means receives signals from said ignition switch, alternator, and a starter when said engine stalls, and blocks these three signals upon the activation of signal generating means.
